(19) United States
(12) Patent Application Publication
(10) Pub. No.: US 2003/0115088 A1
(43) Pub. Date: Jun. 19, 2003

(54) System and method of routing, scheduling, and monitoring a workforce

(75) Inventor: John Thompson, Plano, TX (US)

Correspondence Address: HAYNES AND BOONE, LLP, 901 MAIN STREET, SUITE 3100, DALLAS, TX, 75202, US

(73) Assignee: Crossmark, Inc., Plano, TX (US)

(21) Appl. No.: 10/025,581

(22) Filed: Dec. 18, 2001

(51) Int. Cl. G06F 17/60

(52) U.S. Cl. 705/7

(57) ABSTRACT

A system and method of routing, scheduling, and monitoring a workforce according to which a task module generates a plurality of tasks from a plurality of requests from a plurality of suppliers, wherein the tasks are to be performed at retail store locations. A prioritizing module prioritizes the tasks according to a status of the assigned tasks and a plurality of weighted factors. A routing module assigns one of the prioritized tasks to a member of the workforce, and a client renders the assigned task to the assigned member and collects the status of the task from the member.

This invention relates to a system and method of routing, scheduling, and monitoring a workforce.

### BRIEF DESCRIPTION OF THE DRAWINGS

FIG. 1 is an illustration of an embodiment of the invention.

FIG. 2 is an illustration of one embodiment of an agent.

FIG. 3 is an illustration of a client depicting a task to determine the condition of a retail location.

FIG. 4 is an illustration of a client depicting a series of tasks.

FIG. 5 is an illustration of a client depicting a series of questions.

FIG. 6 is a flowchart illustrating the operation of an embodiment of the invention involving tasks.

FIG. 7 is a flowchart illustrating the operation of an embodiment of the invention involving tasks and questions.

### DETAILED DESCRIPTION OF THE INVENTION

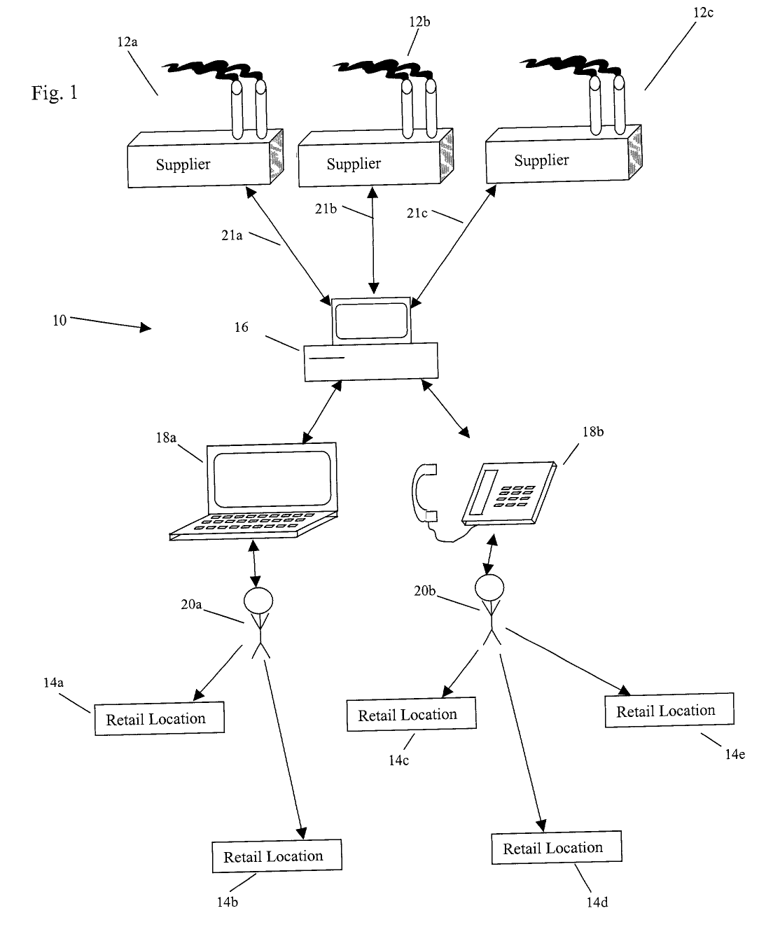

With reference to FIG. 1, a system and method of routing, scheduling, and monitoring a workforce according to an embodiment of the present invention, is referred to, in general, by the reference number 10. The embodiment 10 comprises a series of suppliers 12 that produce goods that are sold at retail locations 14. The goods that are produced by the suppliers 12 can include, for example, grocery products, clothing, pharmaceuticals, hygiene products, and all manner of retail products. To facilitate and monitor the selling and promotion of the goods at the retail locations 14, the suppliers 12 often generate requests relating to the goods. These requests generally fall into three categories: labor requests, validation requests, and information requests. Using grocery products as an example, a labor request may include such requests as stocking products on shelves or racks inside a grocery store, building displays and endcaps, and constructing racks for displaying goods. A validation request can include such activities as determining the status of a retail item (e.g. determining whether a particular brand of sliced bread is in stock or out of stock or placed in the proper endcap), verifying that an item is priced correctly, and checking the attributes of a product in the retail location's record-keeping system. An information request can include gathering information about products that are not made by the supplier 12 making the request or determining the condition of a retail location 14.

As the suppliers 12 create requests, the requests 21 are transmitted to an agent 16. Requests 21 can be transmitted to agent 16 via any known matter of communication, such as via electronic data interchange (EDI), extensible markup language (XML), postal mail, fax, or telephone.

Agent 16 is connected to clients 18a, 18b for communicating tasks generated from requests 21 to members 20 of a workforce. The workforce is composed of members 20 for facilitating the completion of tasks and requests at retail locations 14.

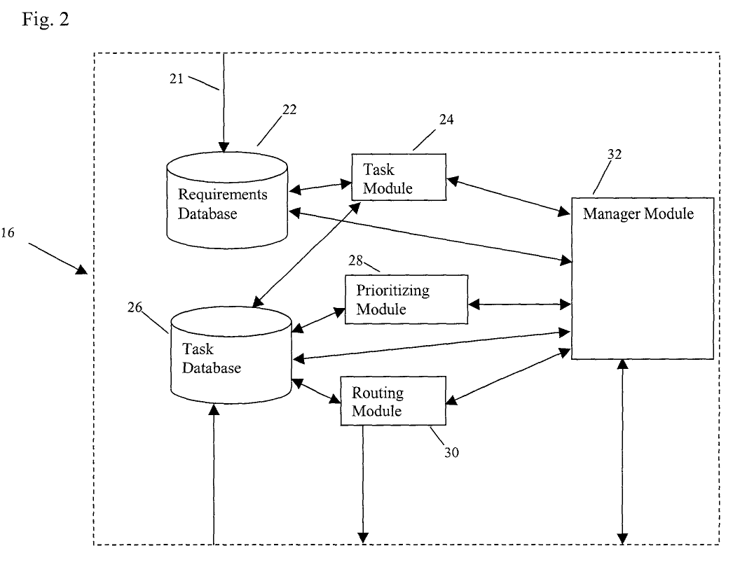

Turning to FIG. 2, one embodiment of agent 16 comprises a requirements database 22 and a task database 26, as well as a task module 24, prioritizing module 28, routing module 30, and a manager module 32, in order to generate tasks from requests, and then facilitate and optimize the scheduling, prioritizing, routing, and monitoring of tasks to be completed at retail locations 14.

The task module 24 is capable of generating a task or series of tasks based on the received requests 21. Further, task module 24 may generate questions to be answered by member 20 (FIG. 1) in order to facilitate or enable the performance of the tasks. The tasks that are generated by task module 24 are input into a task database 26. Tasks are generated by examining a request and then modifying the request to incorporate necessary details. As an example, a labor request might be received requesting that “an endcap be built for brand XYZ lipstick at grocery stores that have a high percentage of female customers.” A task that could be generated from such request might be: “obtain endcap materials from a vendor, build endcap at retail location 14a, stock endcap with brand XYZ lipstick.” Or, if there were multiple grocery stores that met the scope of the requirement, a series of tasks could be generated, such as task 1: “obtain endcap materials from a vendor, build endcap at retail location 14a, stock endcap with brand XYZ lipstick,” task 2: “obtain endcap materials from vendor, build endcap at retail location 14c, stock endcap with brand XYZ lipstick.” Depending on the complexity and scope of each request, a task or series of tasks, each of which might comprise multiple steps, may be generated by task module 24.

A prioritization module 28 prioritizes the tasks in task database 26 in accordance with different factors. A common set of factors are timing and calendaring factors. Using timing and calendaring factors, the first request received and generated into a task results in that task being performed first, i.e. on a “first-come, first-served” basis. Alternatively (or in combination), tasks may be performed on a set time basis, i.e. “conduct tasks for retail location 14a on the 2^{nd} Tuesday of each month.” Another set of factors that can be used to prioritize tasks for retail locations are opportunity based retail factors. Some examples of opportunity based retail factors include:

V=Velocity of a store, determined by dividing the weekly average cash value of the store by the store's square footage,

NP=Number of new products authorized for a store,

NPWI=Weighted importance of new products, preferably 30%,

NS=Number of non-scanned products, i.e. products that have not been scanned or sold at a retail location's point of sale for a defined period of time,

NSWI=Weighted importance of non-scanned products, preferably 25%,

T=Number of tasks for a particular store,

TWI=Weighted importance of a task, preferably 30%,

DOLCF=The day of the last visit to a retail location, preferably calculated by subtracting the julienne day of “today” from the julienne day of the last visit to a retail location, divided by 28 (for example, if the last visit occurred on Jan. 5, 1998 and today was Mar. 1, 1998, the DOLCF would be (60-5)/28 or approximately 1.96), and

DOLCFWI=Weighted importance of the DOLCF, preferably 15%.

One potential manner of utilizing opportunity based retail factors involves assigning a yield value to each task based on the following formula:

Yield=(V*(Σ(NP*NPWI)+Σ(NS*NSWI)+Σ(T*TWI)+(DOLCF*DOLCFWI)

Of course, it is readily understood that other formulas involving the opportunity based retail factors could be used. In addition, other opportunity based retail factors could be incorporated into the formulas.

After utilizing the opportunity based retail factors to determine a yield value for the tasks, the tasks are then sorted by the yield values. It is also possible to combine a timing and calendar based system with an opportunity based retail factor system when prioritizing tasks.

After prioritization, tasks are assigned to members 20 by a routing module 30. Routing module 30 determines the appropriate member 20 to perform the appropriate task by using routing rules. Routing rules are business decisions and physical restraints that dictate which member 20 should receive a given task. Example routing rules include: “retail locations will be assigned from greatest yield task to least yield task,” “members may only visit five retail locations per week,” and/or “members will not be assigned to a task with less than a certain yield.” Other routing rules could modify the yield value for a task by some or all of the following factors:

CWI=The weighted importance of a chain of retail locations, preferably between 0.05 to 2.00,

SWI=The weighted importance of any single retail location, preferably between 0.05 to 2.00,

BWI=The weighted importance of a brand of products for a task, preferably between 0.00 to 2.00, or

MWI=The weighted importance of a supplier, preferably between 0.00 to 2.00.

Using these factors to modify a yield value allows agent 16 to place varying importance on different retail locations, products, and suppliers, resulting in certain tasks being given higher or lower priority when being assigned to members 20.

Referring back to FIG. 1, after routing module 30 applies the applicable routing rules to determine the appropriate member 20 to receive the task, agent 16 then renders the task to client 18 of the appropriate member 20. Client 18 may be any form of remote node, including any web-enabled device, computer, laptop computer, personal digital assistant, as well as a synchronized off-line user interface. Client 18 is capable of unidirectional or bi-directional communication with agent 16, and may further communicate with agent 16 in real-time, in bursts, or delayed bursts. In addition, client 18 may be an interactive voice response system.

For discussion purposes, agent 16 will have rendered the task to be completed to client 18a of member 20a. Once client 18a has received a task from agent 16, member 20a can use client 18a to review the assigned task. Member 20a then performs the assigned task at the appropriate retail location 14. Member 20a may use client 18a to submit the results of the task to agent 16.

Throughout the operation of the system, a manager module 32, as shown in FIG. 2, is capable of accessing the databases and the modules in order to facilitate queries regarding the optimization process. Manager module 32 is capable of providing real-time feedback as to the pending tasks, completed tasks, status of a task currently being performed, the priority value of a task, and the requests outstanding, as well as other information regarding the optimization process. An example would be manager module 32 creates dynamic hypertext markup language documents that comprise the applicable feedback data, such that the documents can be accessed across networks, including intranets and the internet. Another example would be that the suppliers 12 have remote nodes (not shown) that can access the feedback data from manager module 32.

Task module 24, prioritizing module 28, routing module 30, and manager module 32 can be implemented using software, hardware, firmware, or any combination thereof, and while depicted as discrete components, the modules could be combined into a single computer, processor, or any other software, hardware, firmware, or any combination thereof. In addition, while request database 22 and task database 26 are depicted as discrete components, the databases could be combined into a single database. In addition, the components could be accessed across networks and are not required to be integrated into a stand-alone agent 16.

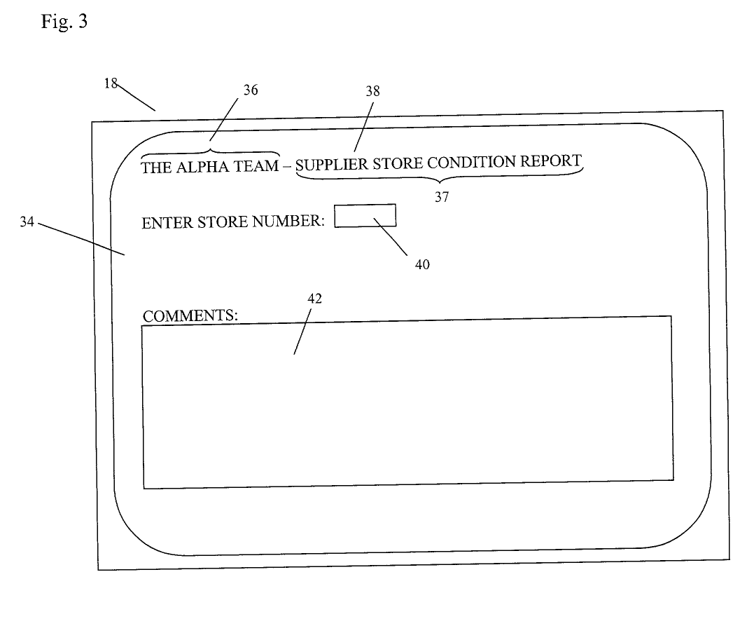

Referring to FIG. 3, an example display 34 of client 18 is depicted showing a task 37. Member name 36 is the name of member 20a (FIG. 1) who will be conducting task 37. In this example, task 37 requires member 36 to determine the condition of a retail location. The specific name of retail location 14 (FIG. 1) is provided at supplier name 38. If retail location 14 has multiple stores, then a store number 40 can be entered to indicate the retail location 14 at which task 37 is being performed. A comment field 42 is provided in order to permit member 36 to report on the condition of the retail location 14.

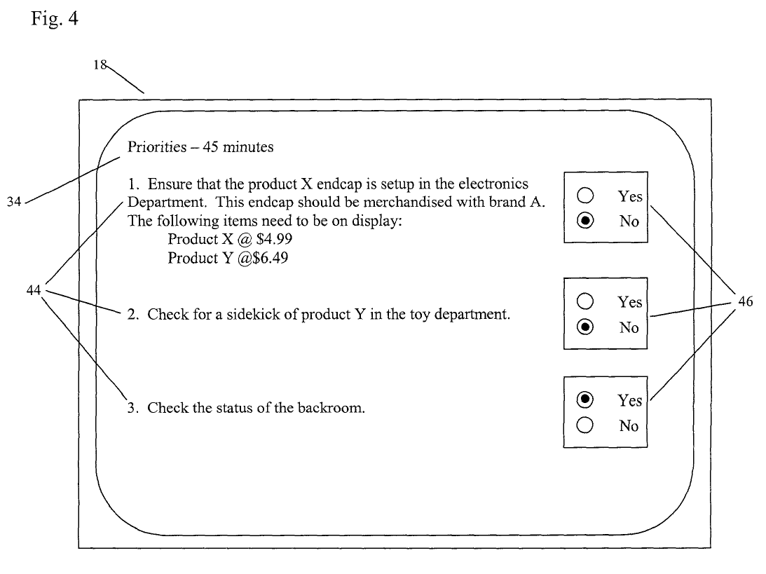

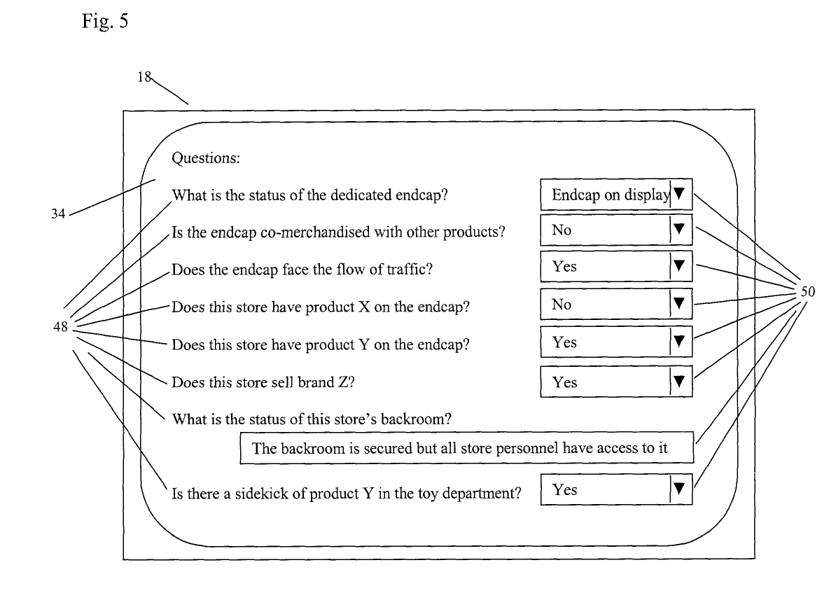

Turning to FIG. 4, another example display 34 of client 18 is depicted listing a series of tasks 44. A series of response buttons 46 are provided to permit member 36 (FIG. 3) to indicate completion of a task 44. In FIG. 5, yet another example of a display 34 of client 18 shows a series of questions 48. Questions 48 can be independent of the tasks 44, or, as in this example, can facilitate the completion of the tasks by querying specific aspects of tasks 44.

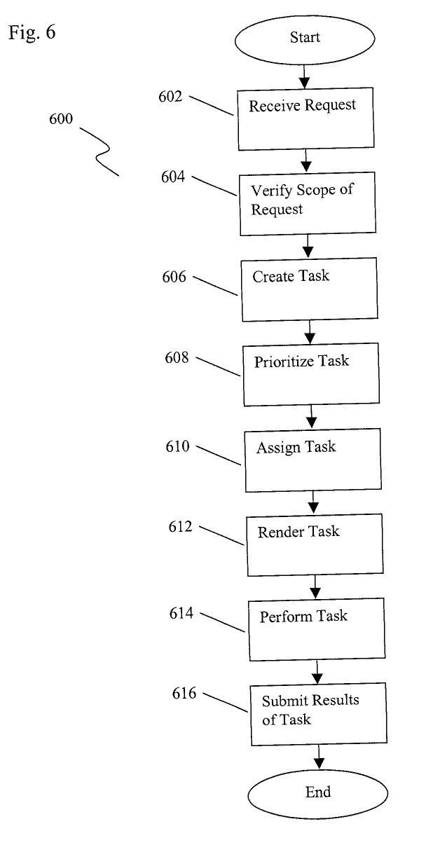

FIG. 6 shows an example operational flow 600 of one embodiment 10 (FIG. 1) of the present invention. A request (e.g., restock canned pineapple in all the grocery stores in Dallas, Tex.) is received by agent 16 from supplier 12, step 602. Agent 16 verifies the scope of the request, step 604. In this example, agent 16 might analyze the number of available members 20 of the workforce needed to visit the grocery stores in Dallas, Tex. as well the level of expertise necessary of members 20 of the workforce with respect to restocking canned pineapple. Of course, other factors could be used in this analysis, as would be understood by those skilled in the art. If the scope of the request is within the capacity of members 20 of the workforce, agent 16 then creates a task (or series of tasks) based on the request, step 606. In the current example, a series of tasks could be created, where each task requires a member 20 to visit one or more grocery stores 14 and then requires a member 20 to restock the grocery store's inventory of canned pineapple. The tasks are then prioritized according to different factors, step 608.

After the tasks are prioritized, each task is assigned to a member 20 in accordance with routing rules, step 610. The applicable task is then rendered to the assigned member 20 via client 18, step 612. After receiving the task, assigned member 20 will travel to the applicable grocery store 14 to complete the task, i.e. restock canned pineapple at that retail location, step 614. Upon completion of the task, member 20 uses client 18 to submit to agent 16 that the task has been completed, step 616.

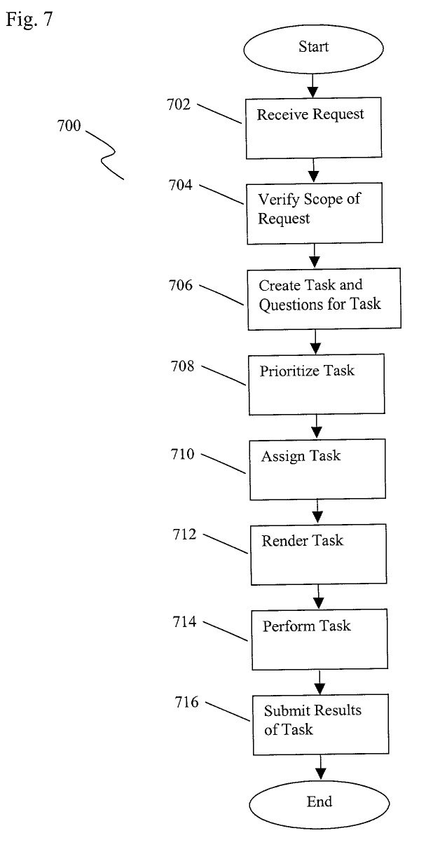

In FIG. 7, showing an operational flow 700 of another embodiment 10 of the present invention, a request (e.g., that agent 16 determine the status of a particular product, for example, photographic film, at grocery store 14b) is received, step 702. Agent 16 verifies the scope of the request, step 704. In this example, agent 16 might analyze whether any of members 20 regularly visit, if at all, grocery store 14b. Of course, other factors could be used in this analysis, as would be understood by those skilled in the art.

If the scope of the request is within the capacity of members 20, agent 16 then creates a task (or series of tasks) based on the request. Along with the generation of the task, task module 24 also generates a series of questions 48 to be answered by member 20 at the grocery store 14b, step 706. These questions could be provided as part of the request from supplier 12, or could be generated based on the type of request, as well as the type of product. An example might be that agent 16 has a database of prepared questions (e.g. “what is the price of the product?”, “where is the product located in the store?”, or “how much stock of the product is available?”) that can be utilized.

The tasks are then prioritized according to different factors, step 708. As discussed, one set of factors that can be used to prioritize tasks for retail locations 14 are opportunity based retail factors. After the tasks are prioritized, each task is assigned to a member 20 in accordance with routing rules, step 710.

The applicable task is then rendered to the assigned member 20 via client 18, step 712. When the task is rendered to the member 20 via, for example, a remote node 18, remote node 18 could then be used by member 20 during performance of the task. In this manner, member 20 could answer the questions via remote node 18 with respect to the photographic film at the grocery store 14b.

In some embodiments client 18 is in communication with agent 16 during the performance of the task and is able to submit results of the task during performance, while in other embodiments, client 18 may be capable of communicating to agent 16 automatically or at preset times to submit results of the task or multiple tasks (whether such tasks are pending, in process, or completed).

In a further embodiment, the tasks and/or questions could be presented via an client 18 that is an interactive voice response system. In this embodiment, client 18 could speak the questions to member 20, and record the member's responses. Additionally, the system might have voice recognition capabilities in order to capture the status of the task from member 20.

After receiving the task, member 20 may travel to the applicable grocery store 14 to perform the task (e.g., examine the grocery store 14 in order to answer the questions in the task), step 714. Member 20 uses client 18 to submit the results and status of the task to agent 16, step 716.

It is understood that while a single request has been depicted in operation in an embodiment of this invention, multiple requests from suppliers 12 can be received throughout the process at different times, and the task list (including the prioritized tasks) can be updated accordingly. In addition, as the status of tasks change, the prioritization of the tasks can be modified. Further, members 20 can be one or more employees or independent contractors of the suppliers, the agent, the retail locations, or any combination thereof.

While the invention has been particularly shown and described with reference to the preferred embodiments thereof, it will be understood by those skilled in the art that various changes in form and detail may be made therein without departing from the spirit and scope of the invention, as set forth in the following claims.

What is claimed is:

1. A system of workforce optimization comprising:
a task module for generating a plurality of tasks from a plurality of requests from a plurality of suppliers, wherein the tasks are to be performed at retail stores;
a prioritizing module for prioritizing the tasks, wherein the tasks are prioritized according to a status of the assigned tasks and a plurality of factors;
a routing module for assigning one of the prioritized tasks to a member of the workforce; and
a client for rendering the assigned task to the assigned member and collecting the status of the task from the member.

2. The system of claim 1 further comprising a managing module for monitoring the status of the assigned tasks.

3. The system of claim 1 wherein the client is a remote node.

4. The system of claim 1 wherein the client is an interactive voice response system.

5. The system of claim 1 wherein the task pertains to at least one product supplied by one of the plurality of suppliers.

6. The system of claim 1 wherein at least one of the plurality of tasks is a series of questions relating to at least one product supplied by one of the plurality of suppliers.

7. The system of claim 1, wherein the routing module assigns one of the tasks to a member of the workforce on the basis of the member's location and a skill level associated with that member.

8. The system of claim 1, wherein the factors are opportunity based retail factors.

9. The system of claim 8, wherein the opportunity based retail factors include velocity of a retail location, number of new products for the retail location, weighted importance of the number of new products, number of non-scanned products, weighted importance of the number of non-scanned products, number of tasks to be performed at the retail location, weight importance of the tasks to be performed at the retail location, a value associated with a length of time since a task was last performed at the retail location, weighted importance of the value associated with a length of time.

10. The system of claim 1, wherein each request is selected from the group consisting of labor requests, validation requests, and information requests.

11. A method of workforce optimization comprising the steps of:
receiving a plurality of requests from a plurality of suppliers;
generating a plurality of tasks from the plurality of requests;
determining a yield value for each task of the plurality of tasks;
prioritizing the plurality of tasks according to a status of the assigned tasks and the yield value of each task of the plurality of tasks;
assigning each of the prioritized tasks to a member of the workforce according to routing rules; and
rendering each assigned task to each assigned member.

12. The method of claim 11, further comprising the step of monitoring the status of the assigned tasks.

13. The method of claim 11, wherein the yield value is determined using opportunity based retail factors.

14. The method of claim 11, wherein each task of the generated plurality of tasks is comprised of a series of questions pertaining to a product provided by at least one of the plurality of suppliers.

15. The method of claim 14, further comprising the step of collecting responses to the series of questions.

16. The method of claim 11, wherein routing rules require that the tasks be assigned on the basis of the member's proximity to the retail location of the task and a skill level associated with that member.

17. The method of claim 11, further comprising the step of re-prioritizing the series of tasks when the status of the assigned task changes.

18. A method of prioritizing tasks to be performed at a plurality of retail locations, comprising:
determining at least one task to be performed at a retail location; for each task, determining a yield value by:
(a) determining a number of new products to be made available for sale at the retail location;
(b) determining a number of non-scanned products available for sale at the retail location;
(c) determining a number of tasks to be performed at the retail location;
(d) modifying the number of new products according to a first factor;
(e) modifying the number of non-scanned products according to a second factor;
(f) modifying the number of tasks according to a third factor; and
(g) summing the values of step (d), (e), and (f); and
assigning the task to a representative according to the yield value.

19. The method of claim 18, wherein step (d) further comprises modifying the modified number of new items according to a velocity value of the retail location.

20. The method of claim 18, wherein the step of assigning the task further comprises modifying the yield value by a value representing the importance of the retail location.

21. The method of claim 18, wherein the step of assigning the task further comprises modifying the yield value by a value representing the importance of a chain of retail locations.

22. The method of claim 18, wherein the step of assigning the task further comprises modifying the yield value by a value representing the importance of a product.

23. The method of claim 18, wherein the step of assigning the task further comprises modifying the yield value by a value representing the importance of a supplier.

24. The method of claim 18, wherein the step of assigning the task further comprises modifying the yield value by a value representing the importance of a brand of products.

25. A computer program for implementing a workforce optimization system, the computer program stored on at least one computer-readable medium and comprising:
instructions for receiving a plurality of requests from a plurality of suppliers;
instructions for determining at least one task to be performed at a retail location from the plurality of requests;
for each task, instructions for determining a yield value by:
(a) determining a number of new products to be made available for sale at the retail location;
(b) determining a number of non-scanned products available for sale at the retail location;
(c) determining a number of tasks to be performed at the retail location;
(d) modifying the number of products items according to a first factor;
(e) modifying the number of non-scanned products according to a second factor;
(f) modifying the number of tasks according to a third factor; and
(g) summing the values of step (d), (e), and (f);
instructions for prioritizing each task according to the yield value;
instructions for assigning each prioritized task to a member of a workforce according to routing rules;
instructions for rendering each assigned task to a client of the assigned member;
instructions for collecting a status of each assigned task from the client; and
instructions for monitoring the status of each task.

26. A method of workforce optimization comprising:
receiving, at a central computer location, a plurality of requests in electronic form from a plurality of retail product suppliers;
generating a plurality of tasks from the plurality of requests, such that each task is to be performed at a grocery store location that is remote from the central computer location;
determining a yield value for each of the plurality of tasks using opportunity based retail factors;
modifying each yield value by importance factors;
prioritizing the plurality of tasks according to the modified yield value of each task;
assigning each task of the prioritized plurality of tasks to a member of a workforce according to routing rules, wherein each member is remotely located from the central computer location;
rendering each task to the assigned member, wherein the member receives the task on a remote node; and
collecting a status of each task from the assigned member via the remote node, wherein the status of each task is accessible from the central computer location by the plurality of retail product suppliers.
